(19) United States
(12) Patent Application Publication
(10) Pub. No.: US 2025/0356687 A1
(43) Pub. Date: Nov. 20, 2025

(54) FLUORESCENCE IMAGING DEVICE

(71) Applicant: Forensic Photonics LLC, Sausalito, CA (US)

(72) Inventors: Dorman Geoffrey Lambright, San Francisco, CA (US); William Martin Peiler, Goose Creek, SC (US); Christopher Guy Battle, Groningen (NL)

(21) Appl. No.: 19/207,995

(22) Filed: May 14, 2025

Related U.S. Application Data
(60) Provisional application No. 63/647,177, filed on May 14, 2024.

(51) Int. Cl. G06V 40/13; G06V 10/14; G06V 40/10

(52) U.S. Cl. CPC G06V 40/1318; G06V 10/14; G06V 40/15

(57) ABSTRACT

An imaging device for capturing a fingerprint is provided. The imaging device can include a light-emitting diode (LED), a lens system configured to project light emitted from the LED, a beam splitting optic configured to direct light received from the lens system at the fingerprint, and a camera configured to capture photons emitted from the fingerprint.

### CROSS-REFERENCE TO RELATED APPLICATIONS

This application claims priority to and the benefit of U.S. Provisional Patent Application No. 63/647,177, filed May 14, 2024 and titled “FLUORESCENCE IMAGING DEVICE,” the full disclosure of which is incorporated by reference, in its entirety, for all purposes.

### BACKGROUND

Crime scene investigators arrive at crime scenes and search for evidence, including fingerprints, to image and otherwise preserve. Investigators can use various tools, including flashlights and cameras to help enhance finding the fingerprints. However, investigators do not have devices that can image the fingerprints clearly other than powder dusting and basic single-lens reflex (SLR) cameras. Often, investigators will take the evidence back to the crime lab for analysis, which can involve cutting a surrounding area of the evidence (such as a wall that the fingerprint lies on). Alternatively, investigators may press a piece of tape on the fingerprint and lift it, but imaging such a print requires highly skilled workers given the level of attention required to image the lifted print. Additionally, there is a backlog on fingerprint analysis due to the amount of time required for analysis of such fingerprints. Given how long the evidence containing the fingerprint may sit before analysis, there can be a heightened risk of contamination and/or tampering. Further, a suspect may flee and be hard to track down if it takes too long to identify the suspect due to the delay in fingerprint analysis. There is therefore a need for a portable device that can enable an investigator to capture a clear image of a fingerprint in an expedient manner.

### SUMMARY

Applicant recognized the problems noted above herein and conceived and developed embodiments of systems and methods, according to the present disclosure, for imaging devices, including fluorescence imaging devices.

In at least one embodiment an imaging device for capturing a fingerprint includes a light-emitting diode (LED), a lens system configured to project light emitted from the LED, a beam splitting optic configured to direct light received from the lens system at the fingerprint, and a camera configured to capture photons emitted from the fingerprint.

In at least one embodiment, an imaging system for capturing a fingerprint includes a light-emitting diode (LED) emitter including a housing having one or more heat removing structures and one or more LEDs. The imaging system also includes a lens system configured to project light emitted from the one or more LEDs. The imaging system further includes an excitation filter arranged along a path receiving a beam of light from the lens system. The imaging system includes an emission filter positioned along the path and configured to filter out wavelengths above a threshold. The imaging system also includes a beam splitting optic configured to direct at least a portion of the beam of light received from the lens system and the excitation filter toward the fingerprint, the beam splitting optic changing a direction of at least the portion of the beam of light by approximately 90 degrees. The imaging system further includes a mirror configured to redirect back reflections. The imaging system also includes a camera configured to capture photons emitted by the fingerprint responsive to interaction with the portion of the beam of light.

In at least one embodiment, an imaging system for capturing a fingerprint includes a light-emitting diode (LED). The imaging system also includes a lens system configured to project light emitted from the LED. The imaging system further includes an excitation filter arranged along a path receiving a beam of light from the lens system. The imaging system also includes a beam splitting optic configured to direct at least a portion of the beam of light received from the lens system and the excitation filter toward the fingerprint, the beam splitting optic changing a direction of at least the portion of the beam of light by approximately 90 degrees. The imaging system includes a camera configured to capture photons emitted by the fingerprint responsive to interaction with the portion of the beam of light.

In at least one embodiment, an imaging system for capturing a fingerprint includes a light-emitting diode (LED) emitter including a housing having one or more heat removing structures and one or more LEDs. The imaging system also includes a lens system configured to project light emitted from the one or more LEDs. The imaging system further includes an excitation filter arranged along a path receiving a beam of light from the lens system. The imaging system also includes an emission filter positioned along the path and configured to filter out wavelengths above a threshold. The imaging system includes a beam splitting optic configured to direct at least a portion of the beam of light received from the lens system and the excitation filter toward the fingerprint, the beam splitting optic changing a direction of at least the portion of the beam of light by approximately 90 degrees. The imaging system includes a mirror configured to redirect back reflections. The imaging system further includes a camera configured to capture photons emitted by the fingerprint responsive to interaction with the portion of the beam of light. The imaging system also includes an interface. The imaging system further includes a housing. The imaging system also includes one or more processors. The imaging system also includes one or more memory devices configured to store instructions that, when executed by the processor, cause the imaging system to capture an image of the fingerprint, perform an automatic exposure operation on the fingerprint, perform a focus-stacking operation on the fingerprint to generate an in-focus image, and store the in-focus image.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. It will be readily understood that the aspects of the present disclosure, as generally described herein, and illustrated in the figures, can be arranged, substituted, combined, and designed in a wide variety of different configurations, all of which are explicitly contemplated and make part of this disclosure. Various embodiments in accordance with the present disclosure will be described with reference to the drawings, in which:

FIGS. 1A and 1B show views of an example fluorescence imaging device that can be utilized to implement aspects of the various embodiments.

FIG. 2 illustrates various components of an example fluorescence imaging device that can be utilized to implement aspects of the various embodiments.

FIG. 3 illustrates various components of an example fluorescence imaging device that can be utilized to implement aspects of the various embodiments.

FIG. 4 illustrates various components of an example fluorescence imaging device that can be utilized to implement aspects of the various embodiments.

FIG. 5 illustrates various components of an example fluorescence imaging device that can be utilized to implement aspects of the various embodiments.

FIG. 6 illustrates an example specimen that can be received in accordance with implementations of the various embodiments.

FIG. 7 illustrates an example method that can be utilized to implement aspects of the various embodiments.

FIG. 8 illustrates an example control and interaction system that can be utilized to implement aspects of the various embodiments.

FIGS. 9A-9E illustrate perspective views of features of an imaging device that can be utilized to implement aspects of the various embodiments.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, and “the” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/−10 percent.

Studies have shown that fingerprint data can be more convincing to a jury than DNA data, showing the importance of having reliable fingerprint data in an expeditious manner. However, fingerprints can start degrading almost immediately after deposit, but can noticeably degrade as soon as a day after deposit, especially depending on the substrate the fingerprint is deposited on. Additionally, having a device that can capture fingerprint data accurately can substantially change the way that an investigator or officer would approach a crime scene. Evidence can be preserved at an earlier point in time on various types of substrates, reducing the risk of contamination and tampering.

An imaging device for capturing a fingerprint is provided. The imaging device can include a light-emitting diode (LED), a lens system configured to project light emitted from the LED, a beam-splitting optic designed to separate, direct, and redirect excitation/emission light at/from the fingerprint, and a camera configured to capture photons emitted from the fingerprint. In at least one embodiment, the beam-splitting optic may include a 552 dichroic beam splitter. However, it should be appreciated that a range of optics may be used with embodiments of the present disclosure. For example, one or more optics may be selected with a wavelength length that is under the emission range of one or more fluorophores of interest. By way of non-limiting example, wavelengths may be between ultraviolet (UV) and infrared (IR). As one example, wavelengths for the optic may be between 200 and 1,000 nm. As another non-limiting example, wavelengths for the optic may be between 250 and 800 nm. Additionally, other example wavelengths may be between 200 and 600 nm, between 200 and 400 nm, between 250 and 750 nm, between 250 and 550 nm, or any other reasonable range.

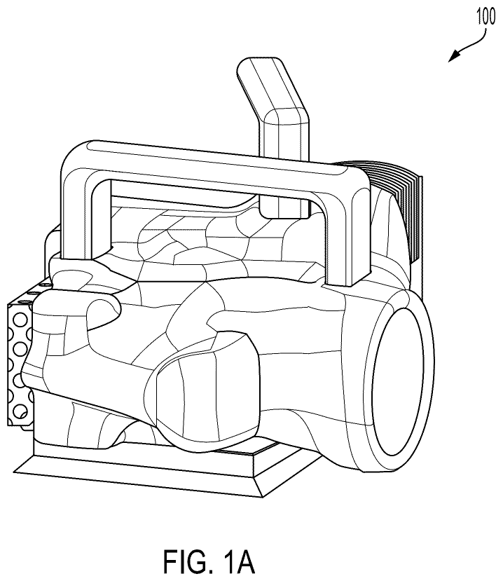

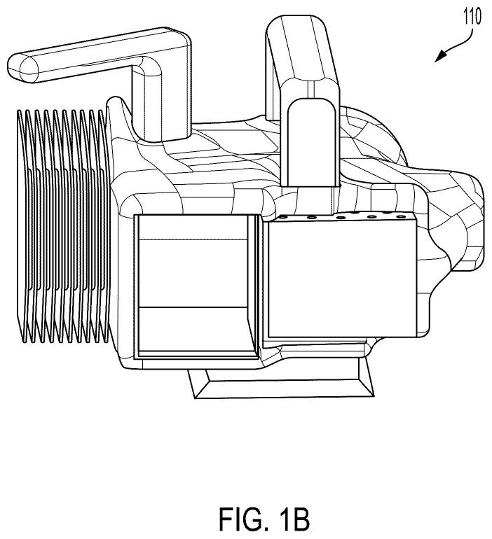

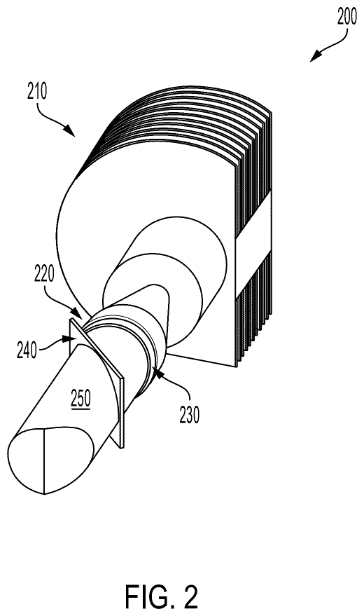

FIGS. 1A and 1B illustrate perspective views 100, 110 of an example fluorescence imaging device that can be utilized to implement aspects of the various embodiments. In accordance with an example embodiment, a fluorescence imaging device can include light emitting diodes (LEDs) to spread light over a large area to help the imaging device detect fluorescence emission over the area. Various details and embodiments of the fluorescence imaging device are described in further detail in FIGS. 2-5 and 8-9E.

FIG. 2 illustrates various components of an example fluorescence imaging device 200 that can be utilized to implement aspects of the various embodiments. In accordance with an example embodiment, an LED emitter 210 can be configured to emit light from one or more LEDs. The LED emitter 210 can be made of aluminum material, and may comprise ridges to maintain the temperature of the LED to ensure the device does not overheat. It should be appreciated that the illustration of the heatsink is by way of non-limiting example only and various other configurations may be used. For example, the illustrated example includes a set of fins extending radially outward from a body. However, other configurations may include more or fewer fins, different fin sizes, no fins, circulating cooling through one or more flow paths, and/or combinations thereof. It may be desirable to include heat dissipation equipment (e.g., heatsinks) with various embodiments to cool and/or draw heat away from the LEDs associated with the LED emitter 210. For example, if the LED overheats, its emission power decreases, which can lead to lower fluorophore signal. As such, an overheated LED can significantly impact image quality and therefore impact quality of match of a suspect to the fingerprint. Accordingly, systems and methods of the present disclosure may incorporate heat dissipation and/or cooling equipment to regulate and/or control heat associated with the LEDs. In accordance with an example embodiment, the LED can be a 2.4 W monochromatic LED centered around 505-525 nm. Various embodiments may include multiple LEDs having different configurations. For example, a set or pair of LEDs may have a first wavelength while a second set has a different wavelength, thereby providing tuning options during operation and/or increasing a range of detection capabilities. It should be appreciated a number and power of LEDs used may be based on one or more design considerations, including maneuverability, weight, cost, and/or the like.

A lens or lens system 220 can be provided to collimate light 250 emitted by the LED emitter 210. The lens can be used to maximize the LED projection on the field of view, and thereby maximize the projection of the field of view back to the imaging device. A collimation lens can be provided with one or more excitation filters 230. The excitation filter(s) 230 can be a short pass 546 excitation filter, as one example. The excitation filter 230 may be a removable component that may be swapped or otherwise reconfigured based on a desired use case. In operation, a light beam 250 going through the collimation lens and excitation filter 230 can then intersect with a beam splitting optic 240 (e.g., a beam splitting dichroic), such as beam splitting dichroic centered at 552 nm. The beam splitting dichroic 240 can then direct the LED light 250 in a determined direction. As discussed herein, 552 nm is provided by way of non-limiting example for the beam splitting optic and a variety of different wavelengths may be used based on desired operating conditions.

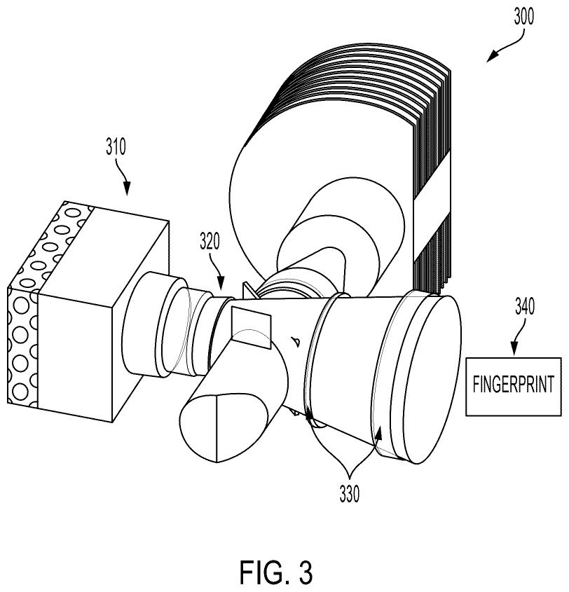

FIG. 3 illustrates various components of an example fluorescence imaging device 300 that can be utilized to implement aspects of the various embodiments. After the LED light 250 of FIG. 2 has been redirected through the beam splitting dichroic 240 of FIG. 2, the redirected light can illuminate a fingerprint 340. Once the fingerprint 340 has been excited by illumination, the fluorophores in the fingerprint can emit photons at a longer wavelength and be received back towards the beam splitting dichroic 240 of FIG. 2. The beam splitting dichroic can allow photons with a wavelength longer than 552 nm to pass through and meet at an additional emission filter 320. It should be appreciated that some photons with a wavelength of approximately 2-10 nm below the center wavelength may pass through, depending on the dichroic quality. Accordingly, systems and methods may be directed toward using a beam splitting dichroic to permit wavelengths longer than approximately 552 nm to pass through, with additional potential wavelengths to account for normal operating conditions and the like. The emission filter 320, in accordance with example embodiments, can be a 575/25 emission filter or a 584/40 emission filter, or NIR filters, or any filter that transmits wavelengths longer than the beam-splitting dichroic and corresponds to the emission wavelengths of the fluorophores the system is designed to use (e.g., Rhodamine 6g, FpNatural, etc.).

After the emitted photons have passed through the emission filter 320, the photons can pass through another lens or set of lenses 330 to help project the emitted photon and further assist in the imaging of the fingerprint 340. The emitted photons can be captured and imaged by a camera 310.

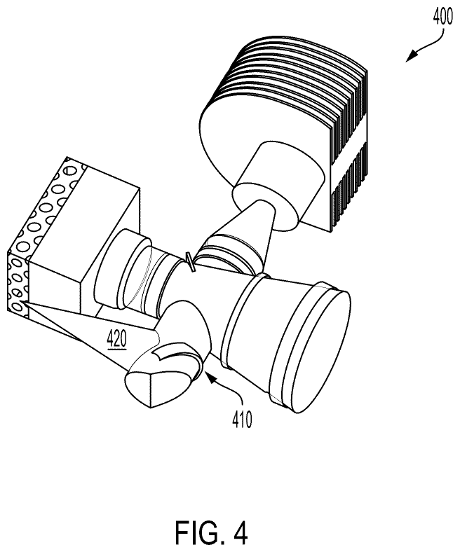

FIG. 4 illustrates various components of an example fluorescence imaging device 400 that can be utilized to implement aspects of the various embodiments. In accordance with an example embodiment, a mirror 410 can be provided to help minimize any back-reflections into the beam system. The mirror can also minimize backlighting 420 to help the imaging device capture a better image and reduce internal reflections caused by unwanted light. As shown in this example, the backlighting 420 is choked down into a cone-shaped (e.g., wider near the mirror 410 and narrower near the camera) to prevent back reflections, which may also be referred to as a light trap.

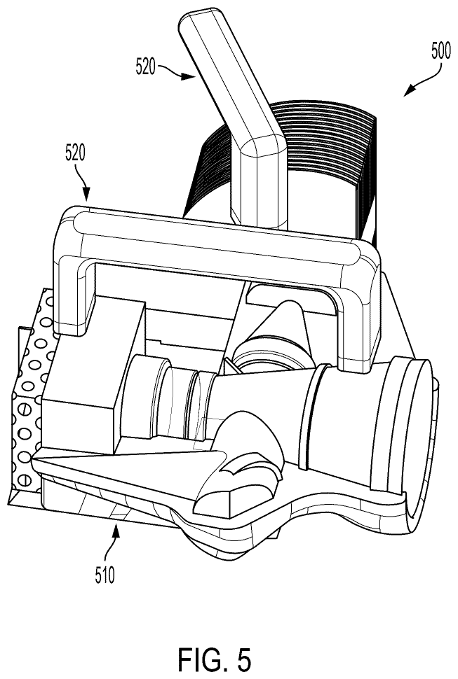

FIG. 5 illustrates various components of an example fluorescence imaging device 500 that can be utilized to implement aspects of the various embodiments. In accordance with an example embodiment, an imaging device can be provided with a base 510 which can be configured to secure onto a tripod rail support system to help stabilize and position the device. The device can also have one or more handles 520 to help a user position and maneuver the device.

In accordance with an example embodiment, the device can be encased in a body. The body can be of a non-reflective, non-fluorescing material. In other embodiments, the body can be constructed with barbeque black nylon material to provide a non-reflective black surface. An inside surface of the body can be painted of the same material. In at least one embodiment, the body may be a rugged material, such as WeatherX™ as one non-limiting example. WeatherX™ may be a durable digital light processing (DLP) photopolymer that is used with three-dimensional (3D) printing applications. As a result, the body may be temperature, chemical, and environment-resistant.

In some example embodiments, the device can be plugged into a power supply or operatable with a rechargeable battery source. In some example embodiments, the LED light source can be run constantly, or can be run at a low constant current that pulses to a higher current when taking image exposures. Additionally, in at least one embodiment, light source intensity may be modulated with a shutter.

In at least some example embodiments, the device can have a one-click button such that a user only needs to push a button to capture an image without having to worry about focusing the device on the fingerprint. A screen on the imaging device can show the fingerprint being captured. In accordance with an alternative embodiment, the user can be provided with a separate button, coupled to the device via wire or wirelessly, to capture the image without needing to touch the physical imaging device. In accordance with yet another example embodiment, the image can be captured via a smart device such as a mobile application. The user can view the imaging window on their mobile device and select a button that would capture the image.

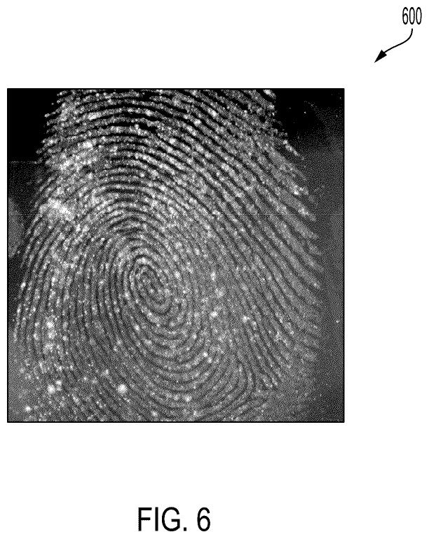

FIG. 6 illustrates an example specimen 600 that can be received in accordance with implementations of the various embodiments. In accordance with one or more methods described herein, a specimen, such as the fingerprint shown in specimen 600, can be captured and stored. In this non-limiting example specific 600, the fingerprint is shown as captured by a LIFT-1 device, which captures the latent prints with a resolution of 1000 pixels per inch—the maximum that can currently be submitted to the latent print databases. Various embodiments of the present disclosure may include a LIFT-500 device, which may be configured to capture prints with 500 pixels per inch, the minimum required for all federal, state, and local latent print databases, and does so by expanding the field of view. For example, Lift-1 images have a field of view with a two-and-a-half-inch diameter, and LIFT-500 images have a field of view diameter of 5 inches. It should be appreciated that embodiments may also be configured to capture images at a variety of alternative resolutions.

In operation, the image can be stored to a memory card or USB drive. In at least some embodiments, the image can be transmitted wirelessly, through encrypted means. The images may be submitted to law enforcement, for example, through various secured channels. Submission of the images may be performed using one or more programs stored on-device, for example, through interaction with a user interface, through a mobile application associated with the device, and/or through software systems that may receive and/or process images captured by the device, among other options.

In accordance with an example embodiment, the stored image can be used on a computer at a laboratory or police department to be submitted to a database. The database can be executed as part of a software package that can be configured to perform one or more pre-processing operations including, but not limited to, marking of the fingerprint before submission. The image can simply be dragged into the software and submitted for analysis, and results can be provided back to the submitter.

The image can be captured without pre-treatment as a raw capture of the latent fingerprint (i.e., deposited via finger on a substrate). Alternatively, the fingerprint can be pre-treated with a spray, such as a diluted rhodamine solution. A fingerprint can be broken down into various components including the amino acids, the lipids, and the proteins. A solution that bonds to each of these components can be applied to the fingerprint prior to image capture. Imaging can be performed for particular color ranges produced by excited fluorophores. A set of emission filters can narrow the detected light to a determined bandwidth of light, isolating the fingerprint fluorophore label apart from autofluorescence of the background.

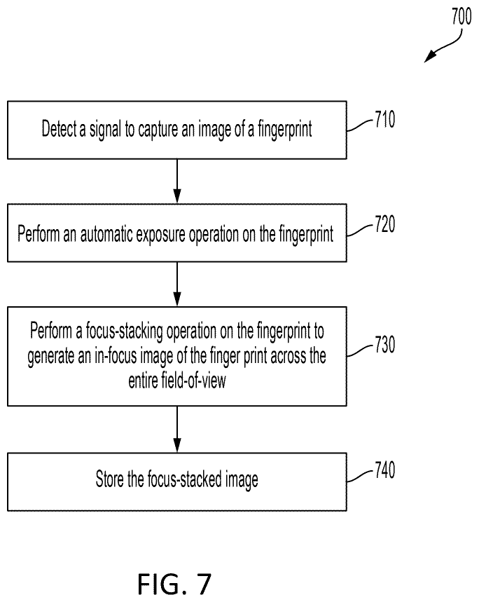

FIG. 7 illustrates an example method 700 that can be utilized to implement aspects of the various embodiments. It should be understood that for any process herein there can be additional, fewer, or alternative steps performed in similar or alternative orders, or in parallel, within the scope of the various embodiments unless otherwise specifically stated.

In accordance with an example embodiment, a signal to capture an image of a fingerprint can be detected 710. For example, an investigator using an imaging device can press a button to capture a fingerprint that the imaging device is positioned at. The imaging device may be positioned at about 120 mm from the fingerprint for imaging, but can be positioned closer or further depending on the light quality and resolution available for image capturing. In some example embodiments, the fingerprint can be pre-treated with a local fumigation (e.g., spraying a solution to lock the fingerprint in place to prevent degradation) and spray (e.g., a spray to enhance detection and analysis of excited fluorophores) applied to the fingerprint to preserve the fingerprint and enable better focusing by the device. One or more embodiments may also, or alternatively, treat the fingerprint with a fluorescent powder to enable image capture.

Once the signal has been detected, the imaging device can perform an automatic exposure operation on the fingerprint 720. In accordance with an example embodiment, an automatic exposure operation can take a pre-image and analyze the brightness of the pre-image. If the brightness is too high, the imaging device can adjust the exposure and take another pre-image. In at least one embodiment, a fully exposed print over a three-dimensional layer may be generated using one or more software solutions and a deep depth of focus. For example, a deep depth of focus may be equal to approximately 1 cm. If the brightness in the second pre-image is measurable, the imaging device can perform a focus-stacking operation on the fingerprint to generate an in-focus image of the fingerprint across the entire field-of-view of the image of the fingerprint 730. A focus-stacking operation, in accordance with an example embodiment, can adjust a point of focus of the image forward and backward by predetermined distances to combine into an in-focus image. An in-focus image may be an overlay of multiple images, which can be helpful for surfaces that are imperfect (e.g., not perfectly flat). The focus-stacked image can be created based on detection of a fluorescence signal received by the imaging device from the imperfect surface (e.g., a “c-stack”).

The focus-stacked image can be stored on a hard drive of a computer or a storage device associated with the imaging device 740. For example, the image can be stored to a memory card or USB drive. In at least some embodiments, the image can be transmitted wirelessly, through encrypted means.

In accordance with an example embodiment, the stored image can be used on a computer at a laboratory or police department to be submitted to a database. The database can be executed as part of a software package that can be configured to perform one or more pre-processing operations including, but not limited to, marking of the fingerprint before submission. The image can simply be dragged into the software and submitted for analysis, and results can be provided back to the submitter.

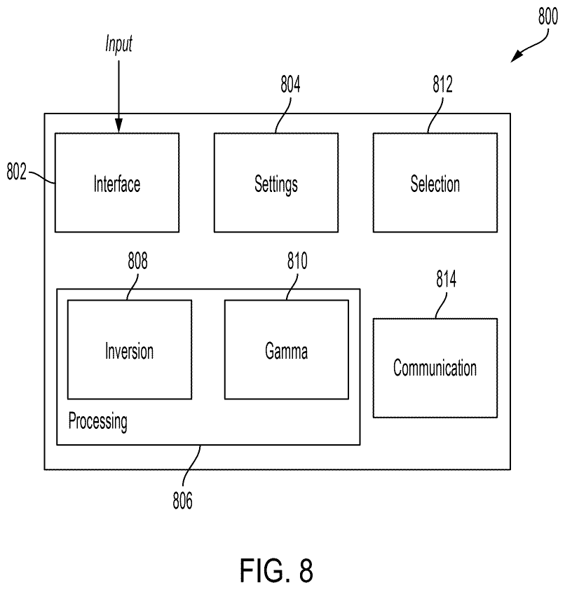

FIG. 8 illustrates an example system 800 that may be used with embodiments of the present disclosure. This example system illustrates various components, modules, systems, engines, and/or the like that may be used to execute post-processing and/or various setting adjustments. In this example, an interface 802 may be associated with one or more image capture devices, such as the device shown in FIGS. 1A and 1B, to enable a user to interact with various software systems stored and executed on the device, for example using one or more processing executing software instructions stored on one or more memories. The interface 802 may include a touch interface, buttons, a slider, and/or combinations thereof. Furthermore, the interface may be communicatively coupled to one or more computer programs executing on a device, such as a mobile application on a mobile phone, a software application on a personal computer, and/or the like. Additionally, in at least one embodiment, one or more web apps may be used to adjust and/or edit various functions associated with the device.

In this example, a settings module 804 may be used to adjust one or more programmable settings associated with the device. By way of example, settings may include exposure, contrast enhancement, view settings, snapshot settings, and/or the like. An operating user may be provided with various settings that may be adjusted and/or configured for a given use case. In at least one embodiment, stored settings may also be used for a given use case. For example, there may be a low light setting that adjusts exposure times and/or changes a brightness for associated LEDs. As another example, there may be different settings for capturing fingerprints from reflective surfaces as opposed to opaque surfaces. In this manner, the device may be tuned for various operating conditions.

Various embodiments may also enable the user to monitor and control various aspects of the image, such as pixel saturation (e.g., red), which may be indicative of overexposure. Upon recognizing the event, the user may provide an indicator to the device that may suggest one or more corrective measures, such as using a different pre-defined setting. In at least one embodiment, light intake may be controlled and/or adjusted by the device itself.

A processing engine 806 may be used to execute one or more pre- or post-processing operations. By way of non-limiting example, an inversion engine 808 may be used to invert pixels (e.g., black to white and white to black) and a gamma engine 810 may be used for gamma correction. For example, a user may interact with the device to view a recently acquired image, for example on a display, and then gamma values may be adjusted (e.g., using a slider or other interface element) to adjust contrast. In at least one embodiment, rather than direct user adjustment, a plurality of images with different gamma values may be presented and the user may select a filter or associated gamma value for use with the particular image. As a result, the user may rapidly identify a high-quality image for use with the particular image being evaluated.

Various embodiments of the present disclosure may integrate one or more software systems to permit user interaction to adjust one or more settings based on factors such as exposure, background, etc. to quickly acquire images. Later post-processing steps may then be implemented in order to bring out details without changing saturation levels. The post-processing steps may be automated or partially automated so that a user that is unskilled with camera adjustment/optimization may select from a group of pre-populated images that have one or more filter settings applied. For example, a selection component 812 may be used to scroll through or otherwise evaluate images, which may be a set number, and then select a “best” or “preferred” image from the list. The user may be provided with a number of different images generated with different settings. In at least one embodiment, a default number of images may be provided and/or the user may determine how many images to provide. Upon selection, the image may be stored along with the gamma value to maintain the quantitative values associated with the image.

Systems and methods may also include a communication module 814 to permit communication with one or more devices, such as a personal device (e.g., a cellular phone, a smart watch, a headset, a personal computer, etc.). The communication module 814 may receive instructions, such as from a mobile application executing on an authorized personal device, and/or may be used to transmit image data to one or more end locations. As discussed herein, various communication protocols may be used, including but not limited to, wireless internet connections, mobile data (e.g., 4G, 5G, LTE, etc.), near field communication systems (e.g., Bluetooth), wired communications, and/or the like.

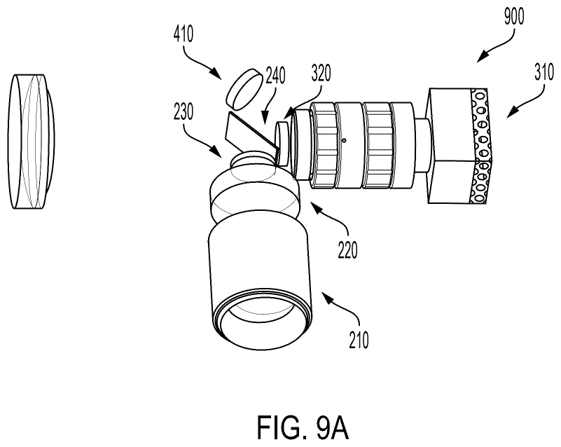

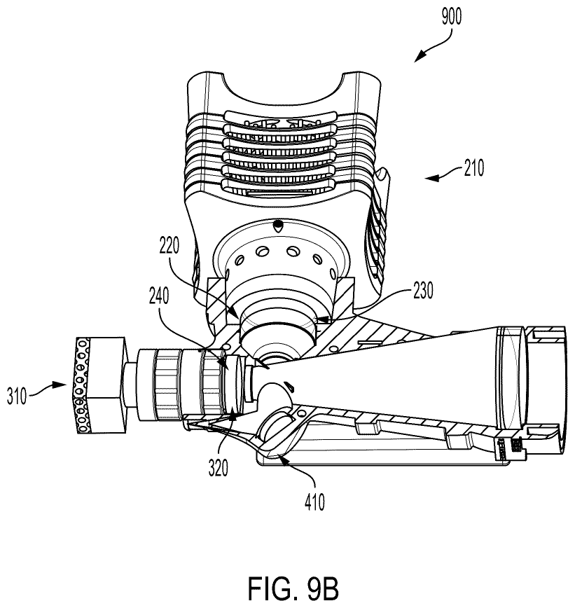

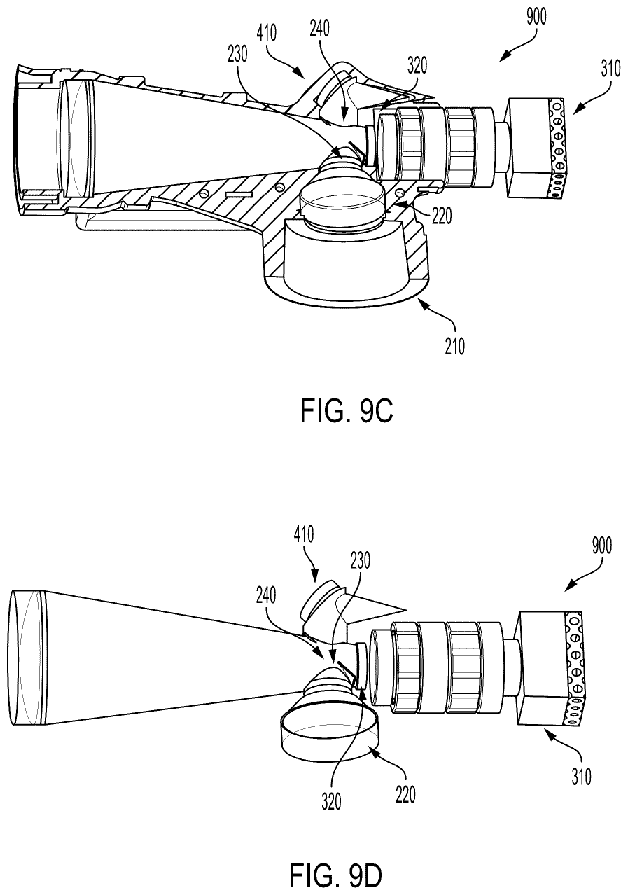

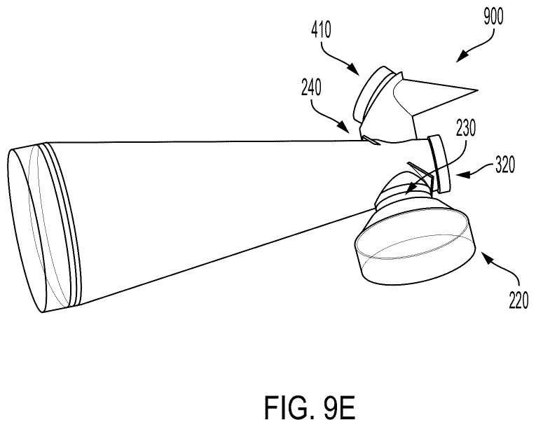

FIGS. 9A-9E illustrate embodiments of an imaging device 900, which may share one or more features with the devices discussed herein. As shown, the LED emitter 210 includes one or more heat dissipation and/or cooling structures, which may include fins or other heat transfer devices to reduce a heat load as a result of LED operation. The LED emitter 210 is configured to produce light that is directed toward the lens system 220. In at least one embodiment, the lens system 220 may be used to collimate light. One or more excitation filters 230 may be associated with the lens system 220. For example, one non-limiting example discussed herein may include a short pass 546 excitation filter.

In operation, the light beam is collimated and directed toward the beam splitting optic 240, which may redirect emitted light in a determined direction, for example along a pathway away from the camera 310. The light may then illuminate a target, such as a fingerprint, and the emission filter 320 may be used to permit passage of photons having a threshold wavelength. The illustrated embodiments also include the mirror 410 and the backlighting 420 discussed herein.

One or more embodiments may also be modified or adjusted to generate a device for imaging one or more reagents, such as Luminol, which may be used to image latent bloodstains. For example, Luminol may be sprayed over a region where it reacts with the iron in blood, producing a luminescent glow. Systems and methods may provide one or more modules or adjustments that facilitate use of various embodiments for the detection of reagents. For example, the excitation filters 230 may be removed because chemical luminescence does not need excitation in order to be visible. Furthermore, the LED, projection lens, and beam splitter may also be removed from the device. However, at least one embodiment may maintain the emission filter 320 to target specific types of light for imaging. Additionally, software systems discussed herein may also be used with the embodiments for imaging blood residue. For example, the interface and settings may be adjusted and the discussed pre- and post-processing steps may be used for selection of various images of blood residue.

The system can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc. Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information.

The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed. Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. An imaging system for capturing a fingerprint, comprising:
a light-emitting diode (LED) emitter including a housing having one or more heat removing structures and one or more LEDs;
a lens system configured to project light emitted from the one or more LEDs;
an excitation filter arranged along a path receiving a beam of light from the lens system;
an emission filter positioned along the path and configured to filter out wavelengths above a threshold;
a beam splitting optic configured to direct at least a portion of the beam of light received from the lens system and the excitation filter toward the fingerprint, the beam splitting optic changing a direction of at least the portion of the beam of light by approximately 90 degrees;
a mirror configured to redirect back reflections; and
a camera configured to capture photons emitted by the fingerprint responsive to interaction with the portion of the beam of light.

2. The imaging system of claim 1, further comprising:
a housing configured to hold at least one of the LED emitter, the lens system, the excitation filter, the emission filter, the beam splitting optic, or the camera, wherein the housing includes a base for mounting the imaging system to a stand and one or more handles.

3. The imaging system of claim 2, wherein the housing is formed from a non-reflective and non-fluorescing material.

4. The imaging system of claim 1, further comprising:
a processor; and
one or more memory devices configured to store instructions that, when executed by the processor, cause the imaging system to:
receive an input corresponding to a pre-defined set of imaging settings;
configure the camera to operate with the pre-defined set of imaging settings; and
capture the fingerprint using the pre-defined set of imaging settings.

5. The imaging system of claim 1, further comprising:
a processor; and
one or more memory devices configured to store instructions that, when executed by the processor, cause the imaging system to:
capture a plurality of images using a plurality of image settings; and
provide, to a reviewing user, the plurality of images.

6. The imaging system of claim 1, wherein the emission filter is at least one of a 575/25 emission filter, a 584/40 emission filter, or a near-infrared filter.

7. The imaging system of claim 1, wherein at least one of the one or more LEDs is centered around 505-525 nm.

8. The imaging system of claim 1, wherein the excitation filter is a short pass 546 excitation filter.

9. The imaging system of claim 1, wherein the beam splitting optic is a dichroic filter centered at 552 nm.

10. An imaging system for capturing a fingerprint, comprising:
a light-emitting diode (LED);
a lens system configured to project light emitted from the LED;
an excitation filter arranged along a path receiving a beam of light from the lens system;
a beam splitting optic configured to direct at least a portion of the beam of light received from the lens system and the excitation filter toward the fingerprint, the beam splitting optic changing a direction of at least the portion of the beam of light by approximately 90 degrees; and
a camera configured to capture photons emitted by the fingerprint responsive to interaction with the portion of the beam of light.

11. The imaging system of claim 10, further comprising:
an LED emitter housing the LED; and
one or more heat dissipating devices associated with the LED emitter.

12. The imaging system of claim 11, wherein the one or more heat dissipating devices include at least one of a heatsink having fins or circulating cooling fluid.

13. The imaging system of claim 10, further comprising:
an emission filter corresponding to a band pass filter positioned along the path and configured to filter out wavelengths above and below a target range.

14. The imaging system of claim 13, wherein the emission filter is at least one of a 575/25 emission filter, a 584/40 emission filter, or a near-infrared filter.

15. The imaging system of claim 10, wherein the LED emits light having wavelengths between an ultraviolet (UV) range and an infrared (IR) range.

16. The imaging system of claim 10, wherein the LED is centered around 505-525 nm.

17. The imaging system of claim 10, wherein the excitation filter is a short pass 546 excitation filter.

18. The imaging system of claim 10, wherein the beam splitting optic is a dichroic filter centered at 552 nm.

19. The imaging system of claim 10, wherein the imaging system further comprises:
an interface;
a housing;
one or more processors; and
one or more memory devices configured to store instructions that, when executed by the processor, cause the imaging system to:
capture an image of the fingerprint;
perform an automatic exposure operation on the fingerprint;
perform a focus-stacking operation on the fingerprint to generate an in-focus image; and
store the in-focus image.

20. An imaging system for capturing a fingerprint, comprising:
a light-emitting diode (LED) emitter including a housing having one or more heat removing structures and one or more LEDs;
a lens system configured to project light emitted from the one or more LEDs;
an excitation filter arranged along a path receiving a beam of light from the lens system;
an emission filter positioned along the path and configured to filter out wavelengths above a threshold;
a beam splitting optic configured to direct at least a portion of the beam of light received from the lens system and the excitation filter toward the fingerprint, the beam splitting optic changing a direction of at least the portion of the beam of light by approximately 90 degrees;
a mirror configured to redirect back reflections;
a camera configured to capture photons emitted by the fingerprint responsive to interaction with the portion of the beam of light;
an interface;
a housing;
one or more processors; and
one or more memory devices configured to store instructions that, when executed by the processor, cause the imaging system to:
capture an image of the fingerprint;
perform an automatic exposure operation on the fingerprint;
perform a focus-stacking operation on the fingerprint to generate an in-focus image; and
store the in-focus image.
